(19) United States
(12) Patent Application Publication
(10) Pub. No.: US 2023/0410100 A1
(43) Pub. Date: Dec. 21, 2023

(54) METHODS AND APPARATUSES FOR UTILIZATION OF EXCESS VEHICULAR RESOURCES

(71) Applicant: FORD GLOBAL TECHNOLOGIES, LLC, Dearborn, MI (US)

(72) Inventors: Brendan F. Diamond, Grosse Pointe, MI (US); Michael Alan McNees, Flat Rock, MI (US); Matthew Penne, Hadar, NE (US); Jonathan Hair, Royal Oak, MI (US); Lorne Forsythe, Novi, MI (US); Keith Weston, Canton, MI (US); Jennifer Bloedow, Dearborn, MI (US); Pramita Mitra, West Bloomfield, MI (US)

(21) Appl. No.: 17/837,350

(22) Filed: Jun. 10, 2022

(51) Int. Cl. G06Q 20/38; G06Q 20/40; B60L 53/64; B60L 58/13

(52) U.S. Cl. CPC G06Q 20/389; B60L 58/13; B60L 53/64; G06Q 20/401

(57) ABSTRACT

A vehicle includes determines that vehicle computing resources will not be fully utilized during an upcoming time period and that exhaustible vehicle power reserves will not be exhausted beyond a threshold based on use of the reserves to power computing using unused computing resources during at least a portion of the time period, those resources suitable for cryptocurrency mining based at least on resource computing capability and a predicted availability of a given resource during the upcoming time period. The vehicle additionally determines a cryptocurrency to mine based on present value of the at least one cryptocurrency producing a positive yield relative to an expense of power used to mine the cryptocurrency using the vehicle computing resources determined to be suitable for cryptocurrency mining and automatically mines the at least one cryptocurrency using the vehicle computing resource determined to be suitable for cryptocurrency mining during the upcoming time period.

### TECHNICAL FIELD

The illustrative embodiments relate to methods and apparatuses for utilization of excess vehicular resources.

### BACKGROUND

Vehicles are becoming ever increasingly complex computing devices, with massive gains on this front expected as vehicles begin to shift to enhance self driving capabilities. Many vehicle systems already have one or more electronic control units (ECUs) associated therewith, and vehicles are continuing to add compute capability and processing as vehicular needs for onboard computing increase.

Sensors and associated computing are expected to add significant investment in compute power and value in vehicle systems, and present vehicles tend to follow a model not often found in many computing devices—they sit quiescent for hours at a time, with no real scenario for usage when travel is not needed.

With electric vehicles having longer lasting power sources that can utilize onboard power without running a motor burning fuel, opportunities exist to leverage the sleeping computing power found in vehicles sitting unused. Moreover, some of this power can even be leveraged when driving, as many vehicle systems are not necessary or engaged at all points during a drive.

### SUMMARY

In a first illustrative embodiment, a vehicle includes a plurality of processors, at least one of which is configured to determine that vehicle computing resources will not be fully utilized during an upcoming time period. The processor is further configured to determine that exhaustible vehicle power reserves will not be exhausted beyond a threshold based on use of the reserves to power computing using unused computing resources during at least a portion of the time period. Also, the processor is configured to determine which vehicle computing resources are suitable for cryptocurrency mining based at least on resource computing capability and a predicted availability of a given resource during the upcoming time period. The processor is additionally configured to determine at least one cryptocurrency to mine based on present value of the at least one cryptocurrency producing a positive yield relative to an expense of power used to mine the cryptocurrency using the vehicle computing resources determined to be suitable for cryptocurrency mining and automatically mine the at least one cryptocurrency using the vehicle computing resource determined to be suitable for cryptocurrency mining during the upcoming time period.

In a second illustrative embodiment, a method includes determining that vehicle computing resources will not be fully utilized during an upcoming time period and determining that exhaustible vehicle power reserves will not be exhausted beyond a threshold based on use of the reserves to power computing using unused computing resources during at least a portion of the time period, including at least preservation of sufficient power projected to be necessary to reach a predicted charging point. The method also includes determining which vehicle computing resources are suitable for cryptocurrency mining based at least on resource computing capability and a predicted availability of a given resource during the upcoming time period. Further, the method includes determining at least one cryptocurrency to mine based on present value of the at least one cryptocurrency producing a positive yield relative to an expense of power used to mine the cryptocurrency using the vehicle computing resources determined to be suitable for cryptocurrency mining and automatically mining the at least one cryptocurrency using the vehicle computing resource determined to be suitable for cryptocurrency mining during the upcoming time period.

In a third illustrative embodiment, a vehicle includes a plurality of processors, at least one of which is configured to examine an upcoming route to determine predicted vehicle computing resource usage at a plurality of locations, based on at least one of fixed or dynamic characteristics of the route. The processor is also configured to, based on the predicted vehicle computing resource usage, determine which onboard vehicle computing resources suitable for cryptocurrency mining will not be fully utilized when the vehicle is at at least one of the plurality of locations. Further, the processor is configured to determine that exhaustible vehicle power reserves will not be exhausted beyond a threshold based on use of the reserves to power computing using one or more of the onboard vehicle computing resources suitable for cryptocurrency mining at the at least one location and, responsive to the vehicle power reserves being determined to not be exhausted beyond the threshold, automatically mine the at least one cryptocurrency using the one or more onboard vehicle computing resources suitable for cryptocurrency mining when the vehicle reaches the at least one location.

### BRIEF DESCRIPTION OF THE DRAWINGS

FIG. 1 shows an illustrative example of a vehicle computing system and cloud based assistance system;

FIG. 2 shows an illustrative process for route planning with mining;

FIG. 3 shows an illustrative process for enroute mining engagement;

FIG. 4 shows an illustrative process for parked-vehicle mining;

FIG. 5 shows an illustrative process for mining engagement and currency determination;

FIG. 6 shows an illustrative process for mining-while-charging;

FIG. 7 shows an illustrative process for choosing how to mine; and

FIG. 8 shows an illustrative process for mining with secondary benefit.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Cryptocurrency mining is a topic that brings to mind underground cooled bunkers with rows and rows of dedicated servers processing algorithms all day long. The reality of mining, however, is that virtually any computing system can do it, just not all systems do it efficiently enough to make the effort or tradeoff in power worthwhile. Further, when dealing with traditional desktop computers, for example, heat concerns and general need of compute cycles for other purposes may play a role in a decision not to utilize the machine for mining.

Vehicles, on the other hand, are a different story. They may include powerful graphical processing units (GPUs) and other resources suited for crypto mining. They tend to sit unused for hours at a time. Even when in use, they often do not use all computing resources. They have massive power reserves that are frequently recharged. They operate outdoors and have many options for natural cooling, such as being relocatable to shade or cooler locations and/or generally moving at speeds that can carry excess heat away from a vehicle.

At the same time, vehicle users interested in using vehicles for conventional travel have a defined set of needs for the vehicle, and the vehicle should be able to preserve resources for those needs as desired. Most people, however, tend to travel in patterns, and their vehicular needs can thus be fairly predictable—e.g. person A drives 30 minutes at 8 AM and 5 PM, and typically for about an hour on the weekends; person B drives 1 hour in the morning at 7 AM and 20 minutes at 3 PM and 20 minutes at 4 PM, with two one hour trips per week and about two hours of weekend travel. Both vehicles have at home recharging and general routes of travel and consistent weekly power needs. Both vehicles sit unused for over 20 hours a day on average, during which time they can also be actually supplied with consistent power. Both can be parked in garages or heat-controlled locations, etc.

The predictability of usage of vehicles, the limited usage of many vehicles, and the large onboard power supplies and computing resources may make vehicles an ideal choice for crypto mining. While the computing resources may not be perfectly tuned for mining, they may be reconfigurable to better mining usages when the vehicle is not in use.

The illustrative embodiments provide non-limiting examples of strategies for and accommodations for using excess vehicle resources (e.g., computing and power) for crypto mining. It is appreciated that other tasks which require power and significant compute, such as general distributed computing, can also benefit from such techniques and the illustrative embodiments may be similarly applicable in any scenario where there is a value for resource usage exchange proposed.

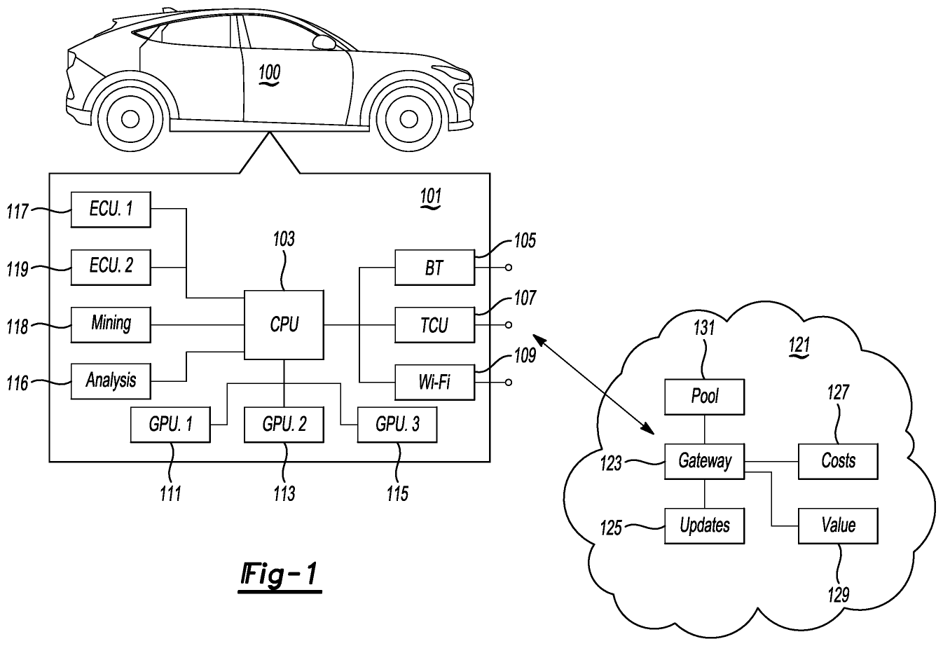

FIG. 1 shows an illustrative example of a vehicle computing system and cloud-based assistance system. In this example, the vehicle 100 is an electric vehicle with an onboard computing system 101. The computing system 101 includes, for example, based on vehicle features and model, one or more onboard processors 103, as well as communications transceivers such as BLUETOOTH 105, telematics control unit 107 and Wi-Fi 109. These communication connections may be usable to communicate with other vehicles for data sharing, as well as provide cloud communication for a variety of services, which may include, in the present examples, value identification (power and coins), marketplaces for excess resources, live data updates to minimize sensor usage, mining pool accesses, user wallets, software updates, etc.

The vehicle computing system 101 may also include a plurality of GPUs, which are highly specialized processors that are often usable for efficient cryptographic mining. Autonomous vehicles (AVs) are expected to include such GPUs for handing the massive amounts of data used while autonomous driving occurs, but that means that those power processors will also be sitting latent while the vehicle is unused. Moreover, in certain situations such as traveling 20 miles on a straight road with no traffic, much of the computing power of the GPUs is unlikely to be needed, and will often go unused.

The computing system 101 may also include a number of ECUs 117, 119. These are very frequently included in even non-AV vehicles and include processing used to control and manage a variety of vehicle systems. Again, many of these resources sit unused even during a journey, and at least some may be suitable, or capable of being rendered temporarily suitable, for usage in a mining enterprise.

Even if the vehicle resources are all not optimized for mining usage, sub-optimal resources may still produce a positive value result when power charges are sufficiently low, and the illustrative embodiments can determine which unused and unneeded resources are suitable for use in mining based on value derived when power charges (and any wear and tear on the components) is contemplated. If component issues are a function of usage, heat and other factors other than time, this may be included as a nominal per/time-unit charge of using any resource, including any additional heat generated or other strain placed on components.

A vehicle analysis process 116 can consider the current state of a vehicle 100 as well as planned usage states (known, projected, etc.) and current resources, which resources are used, which resources are needed within a certain time, which resources are unlikely to be needed, the price of power vs. the value of various crypto currencies, etc. This process, or a comparable cloud-based process, can determine when mining is appropriate based on value and need considerations and take according action. Users may also specify under what conditions to mine, and their own particular constraints on resource preservation. A mining process 118 can be engaged to mine currency. To the extent mining has an effect on vehicle life or value, the mining process can also track which systems were used to mine and how many operational hours were put into mining using those resources.

The cloud 121 may include a gateway 123 to handle many requests for various services incoming into original equipment manufacturers (OEMs). The requests related to mining may include requests for present values of currencies 127, present prices of power in a region where charging is or will occur 120, requests for updates to keep software for mining efficient 125 and accesses to pools or marketplaces 131. Mining pools may share value based on contributed effort or, for example, may provide more lottery-like systems for mining, based on user agreement. Marketplaces may allow users to sell or rent excess compute for mining or other purposes, with a fixed value exchange, typically less than an expected value of mining, but with more consistency.

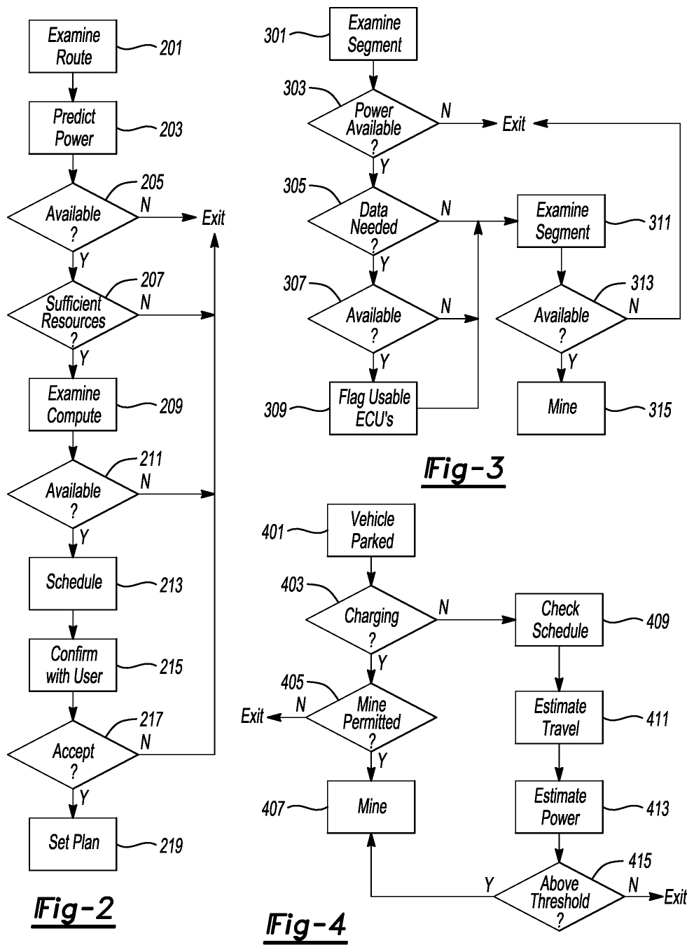

FIG. 2 shows an illustrative process for route planning with mining. Certain routes may have sufficiently predictable parameters, such as traffic, sensor needs, power needs, etc., that allow for advanced planning of mining opportunities. This may also be useful to the extent that mining is sold as a service to others (e.g., rented compute), wherein the user may require some time to set up an arrangement. While a primary model may include users using their own vehicles for mining, users seeking a more consistent value derivation may choose to rent excess resources to another in exchange for a fixed value—e.g., if the expected value of mining is $10/hour, a user may rent resources to someone for $4/hour, but with assurances of guaranteed payment. Since mining is a hit-or-miss opportunity, it is possible to operate for hours without success, and so a user may prefer the guaranteed income stream to cover, for example, ancillary travel expenditures of using the vehicle while traveling. At the same time, a larger entity may want to pay for thousands of such instances to increase the consistency of results and better achieve the expected value of mining when done at scale. Manufactures can provide a marketplace for such exchanges, track payments and mining results, and obtain a small percentage of total value for managing the systems.

The process in FIG. 2 will begin when a route is input or predicted at 201. The route can be to a final or intermediary destination, although considerations related to power resources may account for any and all routes until a known or projected recharging point is reached. For example, a user may typically only charge a vehicle at home. The user may be going out to a location that is an hour away, but the system would account at least for power needed to return home, plus a likely threshold for additional travel before arriving at home. Some predictions about user behavior will be useful in determining total power needs, as well as weather (for HVAC usage), traffic and other considerations. If a user typically does not come home until late in a day, additional buffer may be built in relative to the typical arrival time—e.g., the buffer may be all projected power needs for the trip and return, plus 30% when the user is 8 hours out from a typical arrival time, and all projected power needs plus 15% when the user is 2 hours our from the typical arrival time, the diminishment reflecting the likelihood that the user will arrive home sooner, with likelihood, and have less time for unplanned secondary travel.

The process will predict power needs at 203, which, as noted, can include a return trip or a single direction, if commonly used power resources (such as those known to be used by the user) are located at a trip destination. Buffers of excess power according to strategies or user preferences may also be accounted for in this calculation, so that the expected usage includes a remaining power buffer sufficient to largely ensure the user does not run out of power and/or that accommodates any user preferences for preserving some threshold amount of power.

If excess power appears to be available at 203, the process may further determine if suitable and sufficient compute resources exist at points along a journey for mining. That is, if the vehicle 100 is likely to be largely using the computing resources preferable for mining when traveling, there may not be good locations for resource usage along the trip. High speed negotiation of traffic and many turns may require most computing resources, whereas hours of travel on a straight road with limited traffic and/or at slower speeds may require significantly fewer compute resources.

A conclusion may be drawn based on route characteristics first, if desired, about what sorts of computational resources are likely to be used at certain locations along a route having certain characteristics. The needs may be compared to known vehicle computing resources at 209, if there are locations where excess compute may be available. If the vehicle 100 includes additional computing resources, suitable for mining and not projected to be necessary for travel or other user use at 211, the process may schedule mining at 213. This may simply be planned mining locations, or may include offers for “rent” of computing resources to be placed on an open marketplace. If excess resources prove to be needed at a location (e.g., unexpected traffic or navigation issues), the mining may still not occur.

The process confirms the mining plans with a user, along with power used, power remaining, expected values obtained, types of currency to mine, etc. and if the user accepts at 217, the process may set a mining plan at 219. This can also include recommendations of mining pools, current fixed-values available for rental of mining resources, past successes or lack of success in independent or pooled mining, etc.

FIG. 3 shows an illustrative process for enroute mining engagement. In this example, the vehicle 100 is already moving and the process dynamically considers whether it can engage in mining, even if for a short time period. There may be minimum thresholds for engaging in mining related to resource repurposing, or mining may literally be available on-the-fly for even minutes at a time. Certain pools may require minimum contributions for participation, other pools may be willing to take any resources given for any period of time.

The process examines a present situation and upcoming route segment at 301. The route segment may be of a minimum length, since the vehicle may be moving at a certain speed and the actual needs of a preceding travel situation may be highly predictable but not precisely known. Thus, the prediction may contemplate more than the next few feet of travel, and may consider a segment of a trip over some number of miles, which may also be a function of speed of travel. For example, a vehicle could contemplate projected needs over 10 miles, one mile per 10 miles of speed, over a projected next 10 minutes of travel, etc.

The vehicle 100 considers power needs for both the immediate segment and a longer duration, because the vehicle 100 will presumably need to continue traveling past the segment. Accordingly, the power consideration may be similar to before, which is a consideration of all projected travel until a charging point is reached.

In this example, the vehicle 100 also considers what types of data are needed for the segment 305. This is because sensors and processing can be repurposed if data is available from vehicle to vehicle (V2V) communication and/or vehicle to infrastructure (V2I) communication, etc. This is a harder prediction to make at the onset of a journey, where it is harder to predict what other vehicles may be available to share data for example, at a point 30 miles and 30 minutes away. But it may be easier to know the immediate accessibility of V2V data when the vehicle is only a few miles away. Some vehicles may also choose to monetize their sensor data and act as mobile data points, consuming their own compute and power resources to “sell” sensor data to other vehicles instead of mining. A free and open market may reach an equilibrium on this point, wherein the value of a certain number of vehicles acting as sensor vehicles derive limited per-vehicle value but aggregate value equal to mining. A user can also be given an option to function as either, in a situation where V2V data will allow others to repurpose their sensors to mining. This is also efficient, instead of twenty vehicles gathering the same data, two of those vehicles can act as sensor guides for the group, allowing eighteen others to act as mining vehicles, with limited unnecessary redundant gathering of data. Further, this may allow for vehicles with insufficient power to mine to still derive value, since they may need to gather the sensor data in any event, and the power overhead associated with sharing may be lower than that of mining.

If data is available at 307 (from other vehicles, from the cloud, from infrastructure, etc.), the process may flag ECUs that are usable for mining since their sensing and processing of sensor data capabilities may not be needed or fully needed. Each vehicle 100 may still run some subset of sensors, but may be able to obtain data needed for autonomous driving, cooperative controls, adaptive controls, etc., from other vehicles or entities to a certain extent.

The situation ahead can be compared to the available actual compute resources of the vehicle at 311, as before. Both of the examples contemplate generally determining what sorts of computing are needed and then comparing that to vehicle resources, although the initial consideration could also simply be in light of known vehicle resources. If any excess compute is available at 313, the process may begin mining at 315 (subject to any other constraints as discussed), and/or list compute available for rent on a marketplace.

Any time mining is occurring, the vehicle can continually or periodically monitor power reserves. New destinations, unexpected or unpredicted vehicle behavior, and foregoing predicted charging are all examples of how power reserve threshold requirements can change, because each may represent an event that was not previously contemplated when assessing power requirements. The vehicle can reset threshold minimum power levels at any time and can cease mining any time that vehicle power reserves reach a termination threshold where mining should cease to preserve power.

Similarly, needs for vehicle computing resources can arise unexpectedly. While a road may be predicted to be straight and clear of traffic and weather to remain sunny, any changes to these or other travel variables may trigger an immediate or predicted need for computing resources. The vehicle can spin down any mining responsive to need or predicted need as appropriate, to preserve the computing resources for situational usage. The vehicle can also keep certain computing resources on standby when the vehicle is traveling to ensure that certain resources are never used for mining while the vehicle is in travel. If the vehicle is parked, however, many resources can be used because there is limited need, if any, for the vehicle to use most computing resources for any other purpose.

FIG. 4 shows an illustrative process for parked-vehicle mining. Parked vehicles often represent an excellent opportunity for mining, having limited resource requirements in terms of both power usage and compute. While some limited systems (preconditioning, security, etc.) may still use onboard resources, the vehicle 100 is generally sitting latent with most computing power unused. Parked vehicles are often also charging, which is essentially a limitless power supply subject to price and time allowed to be charging.

Once the vehicle is parked at 401, the process may consider if the vehicle is charging at 403. If the vehicle 100 is charging at home, for example, the connection time may be unlimited (by user choice) and there may be no restrictions on mining. Service stations may rent charging by the hour instead of as a function of power, and so the value-exchange of rental of the space for charging may need to be accommodated in a value calculation. Other free public charging may have a prohibition against mining using free public power, since it incentivizes monopolization of power stations and uses excess power that is not actually free to the entity providing the power. Accordingly, as discussed in more detail later herein, there may be restrictions associated with mining-while-charging and those can be conveyed to the vehicle 100 and followed by software restrictions on mining when necessary. If mining is unrestricted and the vehicle is charging, however, the vehicle may immediately begin mining at 407. Again, this may also be accommodative of any value considerations, such as the value-exchange associated with charging and/or wear and tear on computing resources relative to the value of what is being mined. Typically, users may only want to mine if the value is positive, and even then they may require some multiple of positivity given the hit-or-miss nature of most mining.

If the vehicle 100 is not charging, then the process may check a known or predicted user schedule of usage at 409. All considerations may also account for user location. For example, if a user is parked at home at night, the likelihood of vehicle need may be diminished, but the user may also require a certain amount of power for the next day's predicted travel. If the user is parked at work, it is a near certainty that the user will need to return home at some point that day. Considerations about the projected amount of usage up to a next charging event may be included in the schedule determination. Even if a vehicle is charging, mining may use some portion of the power incoming, and so desired minimum power reserves to be obtained while charging may still be considered when mining while charging—e.g., if the projected charging period is 2 hours, the user may have a known or preferred amount of reserve power needed at the end of the 2 hours, and mining may occur only to the extent that excess power usage will not result in underfilled reserves.

If estimates of travel at 411 and projected power usages during such travel at 413, as well as predicted reserves following charging at 413, reveal that excess power will likely remain at 415, the vehicle 100 can begin mining at 407. Mining can also terminate responsive to overusage of power beyond or near thresholds, excess heat generation, etc. AVs may be capable of relocating to cooler and/or shaded locations if heat plays a role in the mining consideration. Users may be provided with parking guidance when mining is possible, to store the vehicle in a location with a climate more suited to mining. In other instances, such as sub-zero outside temperatures, the user may enjoy a secondary benefit of the vehicle being at least limitedly heated during mining. It may even be possible to recapture heat rising from mining vehicles at some equipped charging points, recycling that heat into energy for reuse by the charging point, depending on how much excess heat is produced and the practicality of funneling the heat to a point for recapture.

In another somewhat interesting example, a building could have an underground garage with “free” onsite power to be used for mining, and the building in return may recapture all the heat pumped into the garage to heat the building during the day while vehicles are parked and mining. These are all also factors that may play a role in deciding when mining is appropriate, permitted and/or preferred.

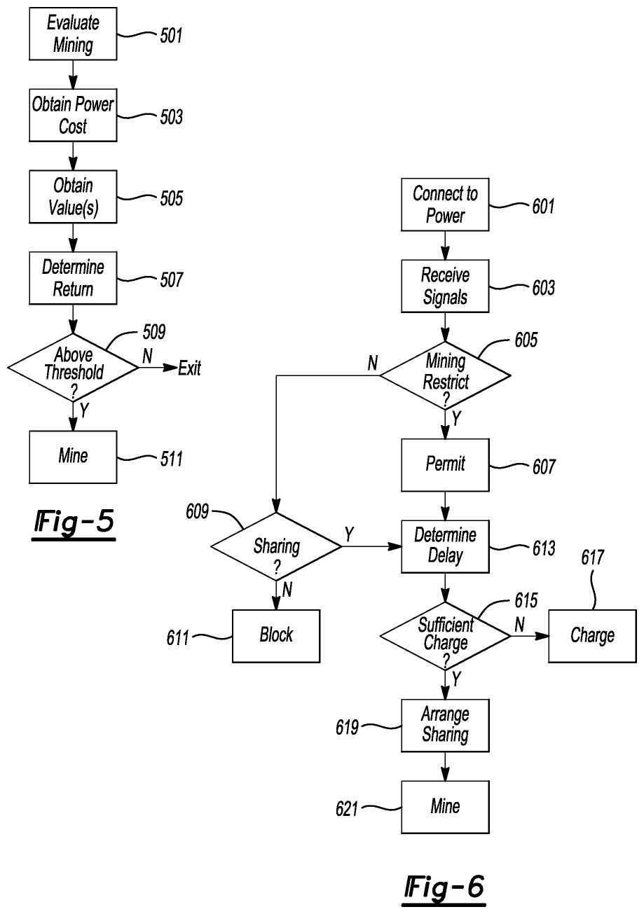

FIG. 5 shows an illustrative process for mining engagement and currency determination. In this example, the process evaluates mining that is about to begin in terms of net overhead. Net overhead can include environmental concerns, heat concerns, wear and tear concerns, etc. Not all possible factors are shown herein, but are within the scope of contemplation. Essentially, this process evaluates possible negatives or preferences indicating user-specific negatives against the expected value derived. On the plus side of the value equation can be things like recapture of heat for power, reuse of heat for heating a vehicle or other location, etc.

In this example, the process obtains a real-time value-exchange required for using power at 503, which can be provided by the server 121. This may not be the present value-exchange for power use, but may be the price for power at a point when the vehicle 100 is expected to charge. That is, if the vehicle is currently charging, the price may be the literal current price. If the vehicle is expected to charge later, the price may be the projected real price for obtaining power at the charging location at the time when charging is projected to occur.

Mining values of various currency are also obtained at 505, which is the current price for the currency. Cryptocurrency can fluctuate wildly during a day, so it is useful to recheck the values periodically and when mining is intended and/or ongoing. Depending on the user value proposition, prices can move in and out of an acceptable range and mining can adapt accordingly. The process determines the expected return at 507 and whether this return is above any threshold recommended, set by the user, above zero, etc. Thresholds may also include usage of renewable power supplies, percent of heat generated reusable for another purpose, etc.

FIG. 6 shows an illustrative process for mining-while-charging. This is an example of the considerations the vehicle 100 may make when determining if to mine while charging. Presently, there are a number of public charging points that are free to use, but the power drawn still is done so at a price to someone. Accordingly, certain points may not want users to freely consume power and derive exclusive benefit and monopolize usage of spaces intended for everyone. At the same time, many of these points go underutilized and lack sufficient computing resources to simply function as mining stations on their own. When a vehicle, which in this context is a massive mobile mining opportunity, pulls up, the point owner may be willing to allow charging as long as the vehicle 100 shares some of the gains. By sharing power and compute resources, both parties benefit from the opportunity.

When a vehicle detects that it is connected to a power supply at 601, signals may be passed wired (through the connection) or wirelessly between the vehicle and power supply at 603. Some data included in these signals may indicate parameters for permissibility of mining while charging. If mining is not restricted at 605 (by intent or because the power supply is private, for example), the vehicle 100 may permit (or simply not block) mining at 607 and determine a likely delay at 613. In this context, the delay is the length of time the vehicle 100 is projected to be parked at the charging point. In many instances, users want a certain amount of power dedicated to reserves when charging, so if the time spent charging will not yield sufficient reserves if mining occurs at 615, the vehicle may simply charge. Predictions about delay can be based on known future travel, observations of past travel habits, the nature of a location where the vehicle is parked (e.g., mall vs. convenience store), express indication, length of a charging reservation time slot, etc.

If there will still be sufficient charge to fulfil user desires and/or projected needs at 615, the process may arrange any necessary value sharing 619 with a charge point owner and begin to mine at 621. In some instances, pay-for-charge charging may still require value sharing, because the vehicle 100 may be able to draw excess power for both mining and charging, in excess of what it would draw were it simply refilling the battery. In other instances, the station owner may allow the user to do whatever they desire within the dedicated and paid-for timeslot.

If there are any restrictions on mining at 605, the process may determine if mining is permitted, but value-sharing is required, at 609. That is, as noted before, the station or point owner may allow charging but only if some of the derived or expected value is shared. This can be in the form of a fixed additional price for mining, or in a hit-or-miss scenario wherein value is only shared if currency is actually obtained. If no mining is permitted under any circumstance, the vehicle 100 may block mining, in order to meet charging rules for that charge point. Otherwise, any required sharing may be arranged at 619 as noted, and the vehicle manufacturer, for example, can derive a small percentage for managing the arrangement as a neutral third party.

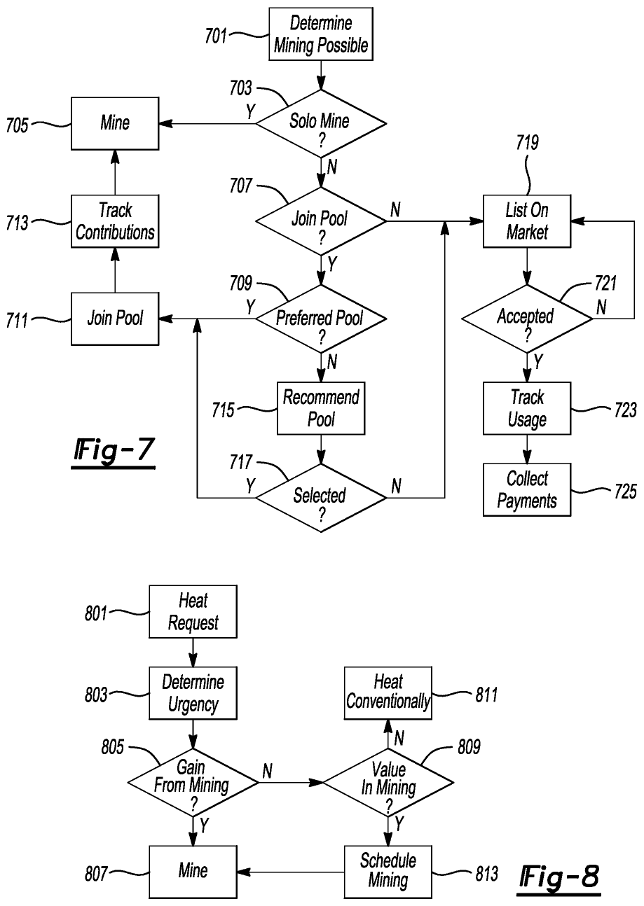

FIG. 7 shows an illustrative process for choosing how to mine. This example contemplates solo mining, pool mining and rental of mining resources. The process may determine at 701 that mining is permissible or practical under a variety of considerations such as those previously discussed, and the like. If solo mining is desired by the user at 703, wherein all gains are the user's, but the likelihood of a zero value result may be higher for any instance, the user may elect to mine alone and mining can begin at 705.

Mining pools may alternatively be desired, which may exist under any agreement based on group members. For example, one mining pool may allocate value based on resources dedicated in terms of compute. Another pool may allocate value based on both compute and local price of power dedicated, and a third may also account for value of wear and tear on components. Users may elect to join whatever pool that fits their particular wants. Some pools may offer more lottery style payouts, with fixed payments and/or group earning over a time period going to a single lucky participant who contributed some, or at least a fixed amount, of overhead to the pool.

If the user wants to join a pool at 707, the user may have a preferred pool at 709. If there is a predefined pool the user can be added to the pool at 711 while mining is occurring and contributions (price, power, wear and tear, compute cycles, etc.) can be tracked at 713 as necessary. Even if a pool does not require certain tracking, the data may be tracked because it may reveal a pool of better value based on that particular user. For example, a user who uses higher priced power may want a pool that considers power prices to be a component of contribution, another user may want pools that require limited minimum compute cycles, etc. This information can be useful for recommending pools at 715, which may occur when the user does not have a preferred pool and/or based on an evaluation by a pool matching service that determines that the user could be deriving better value from a different pool, which can be based at least in part on tracked data related to the user's personal mining habits. Similar to above, if the user selects a different recommended pool at 717, the user can be added to the pool and the resource usage tracked.

If the user does not want to join a pool, the user may still be willing to rent resource usage for a fixed value return at 719. The user can essentially advertise a price for compute on a marketplace, or place the compute up for bid. Because the vehicle may fluctuate in and out of mining scenarios, longer-term deals can be negotiated wherein an entity buys a certain net amount of computing cycles and/or power usage for a total fixed value to be paid when appropriate. Then the entity has the right to any mining that occurs when practical until the allotted resources are used up. On the other hand, on-the-fly transactions can also occur, and some entities may have fixed pricing structures in place to simply immediately acquire and use any available resource as they become available. As noted previously, while the expected value to the vehicle owner may not be as high, the revenue may be guaranteed and thus certain users may prefer the certainty. Meanwhile, other users can effectively pool massive numbers of vehicles on a single behalf, smoothing out the uncertainty by engaging a very large sample size. Manufacturers may even be willing to offer fixed pricing for such resources, since they are in a good position to immediately negotiate with vehicles and may derive some additional value by being able to provide data such as real-time data allowing for sensor usage to be freed up for mining. This can offset the price of providing such data and allow for unlocking of maximum value for all entities involved.

If the rental agreement is accepted and negotiated at 721, the process again can track resource usage at 723 and collect a direct payment for the user at 725 based on the terms of the agreement for resource usage. The user may also be informed of the net value derived (or not derived), so the user can reconsider decisions to rent resources in the future.

FIG. 8 shows an illustrative process for mining with secondary benefit. This is an example of an instance where the heat generated as a result of mining is repurposable for a secondary use, in this instance heating the vehicle. This can be done during preconditioning of a vehicle, to aid in heating a vehicle while traveling, to maintain minimum temperatures necessary for performance, etc.

When a vehicle system requests heat at 801 (e.g., HVAC), the process determines an urgency of the request at 803. That is, a request for heat in preconditioning may be less urgent than a request for heat in a situation where a moving vehicle occupant wants heat, which in turn may be less urgent than a request from a vehicle system that requires minimal temperatures for optimal performance, such as in extreme conditions where, for example, ice is forming where it shouldn't or snow is being gathered in front of a windshield, around a wheel well, etc.

Because mining can produce significant heat, that heat may be redirectable to a variety of uses. If there is a net gain in results from mining to a need for heat at 805, mining may occur regardless of actual monetary value. This same result could be achieved by running any sort of massive processing through the onboard systems, but at least mining almost always has some mitigating value as opposed to simply mindlessly processing data for the sake of quickly generating heat. In such situations, the system will mine at 807.

If there is monetary value in mining at 809, even if the heat benefit is somewhat nominal at 805 (e.g., in preconditioning, where the heat is useful, but not necessary), the process may schedule mining to occur in concert with the heating event at 813. So, for example, when it is 50 degrees outside, and the preconditioning is expected to heat the vehicle to 65 degrees, the value from mining to that heat gain may be minimal, if the vehicle can be heated conventionally at 811. At the same time, if it is 0 degrees outside, the vehicle may heat up much more quickly and/or may be able to use heat for specific functions like rapid de-icing of windows, and so may occur regardless of whether the monetary value meets common user thresholds for mining. Users can still block this behavior, but may elect to allow it to continue in the interest of rendering the vehicle 100 usable more quickly. A user leaving a now-closed business late at night on a cold and snowy night will likely want a vehicle heated and rendered usable as quickly as possible.

The illustrative embodiments and the like propose a number of approaches for using available vehicle resources to maximize potential and fully optimize the lifecycle of those resources. Users can choose to use the resources in a responsible manner, and may still benefit significantly from the processing power that they possess, but which often goes unused.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a plurality of processors, at least one of which is configured to:
determine that vehicle computing resources will not be fully utilized during an upcoming time period;
determine that exhaustible vehicle power reserves will not be exhausted beyond a threshold based on use of the reserves to power computing using unused computing resources during at least a portion of the time period;
determine which vehicle computing resources are suitable for cryptocurrency mining based at least on resource computing capability and a predicted availability of a given resource during the upcoming time period;
determine at least one cryptocurrency to mine based on present value of the at least one cryptocurrency producing a positive yield relative to an expense of power used to mine the cryptocurrency using the vehicle computing resources determined to be suitable for cryptocurrency mining; and
automatically mine the at least one cryptocurrency using the vehicle computing resource determined to be suitable for cryptocurrency mining during the upcoming time period.

2. The vehicle of claim 1, wherein the determination the threshold is higher than amount of power projected to be necessary to reach a predicted charging point.

3. The vehicle of claim 2, wherein the predicted charging point is predicted based on historical charging behavior observed and recorded for the vehicle.

4. The vehicle of claim 1, wherein the positive yield is further determined relative to the expense of power plus a predefined expense of wear on utilized computing resources occurring as a result of the mining.

5. The vehicle of claim 1, where at least one of the processors is further configured to:
monitor vehicular needs for the vehicle computing resources used for mining to predict a need for one or more of the vehicle computing resources used for mining; and
responsive to the need, cease using any vehicle computing resources used for mining that are necessary to meet the need.

6. The vehicle of claim 6, wherein the need is determined based at least on part on travel conditions of a vehicle in motion.

7. The vehicle of claim 7, wherein the travel conditions include at least one of weather, traffic or an unpredicted incident along a road on which the vehicle is traveling.

8. The vehicle of claim 1, where at least one of the processors is further configured to:
re-evaluate vehicle power requirements while mining is occurring to accommodate changing power reserves and changing power needs, to determine if power reserves are approaching a threshold beyond which insufficient power will remain based on the changing power needs; and
responsive to the power reserves reaching the threshold, cease mining.

9. The vehicle of claim 8, wherein the changing vehicle needs include at least one of a new destination being entered, a vehicle traveling in a manner not previously predicted during a prior determination that exhaustible power reserves would not be depleted, or a vehicle foregoing charging at a location where charging was predicted to occur.

10. A method comprising:
determining that vehicle computing resources will not be fully utilized during an upcoming time period;
determining that exhaustible vehicle power reserves will not be exhausted beyond a threshold based on use of the reserves to power computing using unused computing resources during at least a portion of the time period, including at least preservation of sufficient power projected to be necessary to reach a predicted charging point;
determining which vehicle computing resources are suitable for cryptocurrency mining based at least on resource computing capability and a predicted availability of a given resource during the upcoming time period;
determining at least one cryptocurrency to mine based on present value of the at least one cryptocurrency producing a positive yield relative to an expense of power used to mine the cryptocurrency using the vehicle computing resources determined to be suitable for cryptocurrency mining; and
automatically mining the at least one cryptocurrency using the vehicle computing resource determined to be suitable for cryptocurrency mining during the upcoming time period.

11. The method of claim 10, wherein the predicted charging point is predicted based on historical charging behavior observed and recorded for the vehicle.

12. The method of claim 10, wherein the positive yield is further determined relative to the expense of power plus a predefined expense of wear on utilized computing resources occurring as a result of the mining.

13. The method of claim 10, further comprising:
monitoring vehicular needs for the vehicle computing resources used for mining to predict a need, based at least in part on travel conditions of a vehicle in motion, for one or more of the vehicle computing resources used for mining; and
responsive to the need, ceasing using any vehicle computing resources used for mining that are necessary to meet the need.

14. The method of claim 13, wherein the travel conditions include at least one of weather, traffic or an unpredicted incident along a road on which the vehicle is traveling.

15. The method of claim 10, further comprising:
re-evaluating vehicle power requirements while mining is occurring to accommodate changing power reserves and changing power needs, to determine if power reserves are approaching a threshold beyond which insufficient power will remain based on the changing power needs; and
responsive to the power reserves reaching the threshold, ceasing mining.

16. The method of claim 15, wherein the changing vehicle needs include at least one of a new destination being entered, a vehicle traveling in a manner not previously predicted during a prior determination that exhaustible power reserves would not be depleted, or a vehicle foregoing charging at a location where charging was predicted to occur.

17. The method of claim 10, wherein the upcoming time period includes a known route and wherein the automatic mining includes scheduling usage of the vehicle computing resource determined to be suitable for cryptocurrency mining at one or more locations along the route and automatically mining responsive to the vehicle reaching the one or more locations.

18. The method of claim 10, wherein the upcoming time period is based on an upcoming segment of road of at least one of: predefined distance, predefined travel time, or having at least one characteristic predefined as suitable for mining.

19. The method of claim 10, wherein the upcoming time period is based on at least one of a known or predicted duration of a vehicle parked state.

20. A vehicle comprising:
a plurality of processors, at least one of which is configured to:
examine an upcoming route to determine predicted vehicle computing resource usage at a plurality of locations, based on at least one of fixed or dynamic characteristics of the route;
based on the predicted vehicle computing resource usage, determine which onboard vehicle computing resources suitable for cryptocurrency mining will not be fully utilized when the vehicle is at least one of the plurality of locations;
determine that exhaustible vehicle power reserves will not be exhausted beyond a threshold based on use of the reserves to power computing using one or more of the onboard vehicle computing resources suitable for cryptocurrency mining at the at least one location; and
responsive to the vehicle power reserves being determined to not be exhausted beyond the threshold, automatically mine the at least one cryptocurrency using the one or more onboard vehicle computing resources suitable for cryptocurrency mining when the vehicle reaches the at least one location.
